(19) United States
(12) Patent Application Publication
(10) Pub. No.: US 2018/0005203 A1
(43) Pub. Date: Jan. 4, 2018

(54) DISPLAY NOTIFICATION OF INFORMATION UPON PAYMENT AUTHORIZATION

(71) Applicant: SQUARE, INC., San Francisco, CA (US)

(72) Inventors: Brian Grassadonia, San Francisco, CA (US); Ayo Omojola, San Francisco, CA (US); Jochen Bekmann, San Francisco, CA (US); Dhanji Prasanna, San Francisco, CA (US); Peter Westen, San Francisco, CA (US)

(21) Appl. No.: 15/199,596

(22) Filed: Jun. 30, 2016

(51) Int. Cl. G06Q 20/10; H04W 68/00; G06Q 20/40

(52) U.S. Cl. CPC G06Q 20/102; G06Q 20/409; H04W 68/005

(57) ABSTRACT

A notification message system can use a payment request message during an authorization process to generate a message recommending a tip amount. A customer provides a payment card number at a merchant. A merchant initiates an authorization request using the payment card number and an amount. The authorization message is transmitted to a merchant-acquirer, who then transmits the authorization message to issue processing system, who in turn transmits the authorization message to a consumer computing system. The consumer computing system can use an industry code to determine whether the merchant is one that customarily receives a tip. The consumer computing system calculates a suggested tip amount based on the transaction amount, then generates a message with the tip amount and pushes the message to a mobile device of the user associated with the payment card number. The customer can continue the transaction using that tip amount.

### BACKGROUND

Various tip calculation tools can help customers choose an appropriate tip amount and perform the correct addition when paying a bill. These conventional tools are standalone, however, and are not integrated with a payment authorization system associated with the merchant's point of sale system.

Certain merchants, such as restaurants and taxi services, present an option for a tip or gratuity along with the payment. At a restaurant, for example, a credit card is used twice: first, to authorize a charge based on the subtotal of a bill and generate a receipt; and second, to capture the amount of a tip indicated by the diner on the receipt.

If the server alters a tip (and thus the total bill amount) after the customer has signed the receipt, the customer's only opportunity to discover and rectify the fraud is to review the credit card or bank statement. The customer receives the statement weeks after the event, and the customer must remember the correct total, then initiate a charge back, either through a card issuer or the merchant. Many victims of such fraud never discover the theft.

Conventional payment systems do not efficiently integrate a mobile device into the authorization and settlement process to allow for alerts and fraud detection.

### BRIEF DESCRIPTION OF THE DRAWINGS

The accompanying drawings constitute a part of this specification and illustrate an embodiment of the invention and together with the specification, explain the invention.

FIG. 1 illustrates a system architecture according to an example embodiment.

FIG. 2 illustrates a data flow diagram of a tip amount notification message system, according to an example embodiment.

FIG. 3 illustrates a graphical user interface of a mobile device that received a push notification message, according to an example embodiment.

FIG. 4 illustrates a graphical user interface of a mobile device that received a push notification message, according to an alternative example embodiment.

FIG. 5 illustrates a graphical user interface of a mobile device that presents a selection of a tip based on recommended tip amounts, according to an example embodiment.

FIG. 6 illustrates a data flow diagram of a warning notification message system, according to an example embodiment.

### DETAILED DESCRIPTION

Technology is disclosed that uses an electronic payment stream to generate a notification to a customer for a suggested tip amount on a purchase, and the electronic payment stream offers additional security to ensure that the desired tip amount is captured. The term “tip” as used herein refers to an additional payment above the minimum payment for the service, and may be characterized as a tip, gratuity, bonus, gift, or donation. A tip is customary in industries such as restaurants, barbers, maids, taxi drivers, and bartenders.

A conventional tip calculator can provide an amount to pay based on a subtotal of a bill and a percentage to tip. For example, if the subtotal of the bill is $100, and the customer wants to tip 20%, the tip calculator may suggest a tip amount of $20. This calculator function may be provided by an application on a mobile device. When the customer desires a tip calculation (such as upon receiving a bill), the customer can input the subtotal and tip amount, and the application can present a suggested tip amount on a user interface. This application is not tied to the payment process and must be initiated by the customer.

In some instances, a receipt presented by a merchant may include suggested tip amounts for that subtotal. For example, after charging a subtotal to a customer's card, a restaurant prints a receipt with fields for entering a tip amount, a total amount, and a signature of the customer. The receipt may also include a calculation, whereby a receipt for a bill of $100 would recite $20 for 20%, $15 for 15%, or $10 for 10%. The tip calculations are printed on the receipt by a point of sale system, but the calculation is merely a suggestion and does not add any security to the payment process.

EMV chip cards are processed differently from magnetic stripe cards. For example, EMV chip cards may only allow the tip amount to be entered before processing the card, and a tip amount may not be added at a later time. In a conventional magnetic stripe card transaction, the customer signs the receipt and adds the tip amount along with the total amount. Because an EMV chip card transaction may not allow for the tip amount to be added, it is desirable to have a payment process that integrates the addition of a tip to the bill. In an attempt to address this issue, a card issuer may allow authorization of a bill for an additional 20% to account for a tip to be added, but such a workaround adds complexity and uncertainty to the payment stream.

In contrast, the notification message system introduced here can use a payment request message during an authorization process to generate a message recommending a tip amount. In an example process, a customer provides a payment card number for payment at a merchant, such as a customer providing a payment card to a waiter at a restaurant. The merchant swipes or inputs the card into a point of sale terminal, which initiates a payment request authorization message (or “authorization message”) using the payment card number for an amount. An authorization message includes the payment card number (e.g., a credit card number) and a transaction amount. The authorization message is transmitted to a merchant-acquirer, who then transmits the authorization message to issue processing services, such as Visa or MasterCard. The issue processing services transmits the authorization message to consumer computing system. The consumer computing system can use a merchant category code to determine whether the merchant is one that customarily receives a tip, such as a non-quick service restaurant. When the merchant is a type that customarily receives a tip, the consumer computing system calculates a tip amount based on the transaction amount. The consumer computing system generates a message and pushes the message to a mobile device of the user associated with the payment card number. The message pushed to the mobile device includes a suggested tip amount. The notification message is pushed upon processing of the authorization message, because the customer should receive the recommended tip amount at the time of the transaction. A significant delay in the push notification message may cause the customer to wait an undesirable amount of time or be too late for the customer to use during the transaction. The customer can write that tip amount on a receipt presented by the merchant. The merchant will submit the total amount, along with the tip, for authorization.

The notification message system automatically triggers the generation and push of a notification message having a tip amount upon receiving the authorization message in the payment stream. The notification message is pushed to the mobile device within a certain time period to ensure it is useful in the transaction. If, however, the consumer computing system is unable to deliver the message within the certain period of time, then the consumer computing system may delete the notification because it would be too late to affect the transaction. So the consumer computing system receives the authorization message, which automatically initiates the calculation of the tip amount and the generation of a notification message with that calculated tip amount. The notification message can then be pushed from the consumer computing system to the mobile device without requiring a request to be inputted in or transmitted from the mobile device. Such a notification message is generated and transmitted within a network-based computing environment and enabled by the consumer computing system and the functionality of messaging to a mobile device. The notification message cannot be generated in a similar manner without being integral to the payment stream. The integrated consumer computing system is able to perform functionality that is not present in human-implemented transactions.

The notification message system can also more securely ensure that the customer's selected tip amount is not revised by a merchant. In an example embodiment, once the customer receives the push notification message on the mobile device, the customer can select a tip amount by tapping a corresponding selectable link (e.g., button) on the mobile device. The selection is transmitted by the mobile device to the consumer computing system. The customer then completes the receipt with the tip amount and signs the receipt. If the merchant alters the tip amount, thereby also changing the total payment amount, the transaction may be declined, and the consumer computing system will push a notification message to the consumer warning of an unexpected capture amount. In one example, upon determining that total payment amount does not match, the consumer computing system may generate a request to decline the transaction (e.g., cancel authorization or capture, request chargeback from system of record for the total amount of the transaction).

The notification message system automatically triggers the generation and push of the unexpected capture amount notification message upon receiving the authorization message for an improper amount in the payment stream. The consumer computing system receives the authorization message, which automatically initiates the determination of whether the total amount matches the selected tip amount and total transaction amount. Upon a determination that there is no match, the consumer computing system may decline the transaction and automatically generates the notification message alerting the customer to the unexpected capture amount. The notification message can then be pushed from the consumer computing system to the mobile device without requiring the mobile device to request a confirmation of the amount in the authorization message. Such a notification message is generated and transmitted within a network-based computing environment and enabled by the consumer computing system and the functionality of messaging to a mobile device. The notification message cannot be generated in a similar manner without being integral to the payment stream. The integrated consumer computing system is able to perform functionality that is not present in human-implemented transactions.

The notification technology introduced here can be embodied as special-purpose hardware (e.g., circuitry), as programmable circuitry appropriate programmed with software and/or firmware, or as a combination of special-purpose and programmable circuitry. Hence, embodiments may include a machine-readable medium having stored thereon instructions that may be used to cause one or more processors to perform the methods, variations of the methods, and other operations described here. The machine readable medium may include, but is not limited to, floppy diskettes, optical discs, compact disc read-only memories (CD-ROMs), magneto-optical discs, read-only memories (ROMs), random access memories (RAMs), erasable programmable read-only memories (EPROMs), application-specific integrated circuits (ASICs), magnetic or optical cards, flash memory, or other type of media/machine-readable medium suitable for storing electronic instructions.

The present disclosure is here described in detail with reference to embodiments illustrated in the drawings, which form a part here. Other embodiments may be used or other changes may be made without departing from the spirit or scope of the present disclosure. The illustrative embodiments described in the detailed description are not meant to be limiting of the subject matter presented here.

Various embodiments will now be described in further detail. The following description provides specific details for a thorough understanding and enabling description of these embodiments. One skilled in the relevant art will understand, however, that the embodiments discussed herein may be practiced without many of these details. Likewise, one skilled in the relevant art will also understand that the embodiments can include many other obvious features not described in detail herein. Additionally, some well-known structures or functions may not be shown or described in detail below, to avoid unnecessarily obscuring the relevant description.

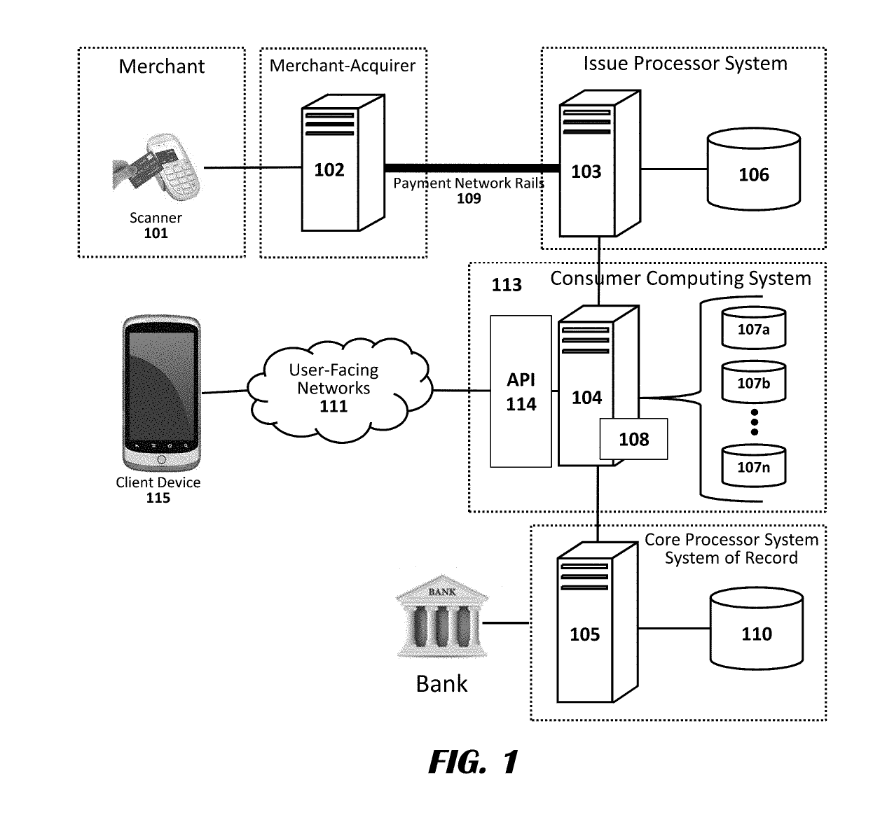

FIG. 1 illustrates a system architecture of an electronic payment system according to an example embodiment. A merchant computing device 101 can be a payment card payment processing terminal, such as a payment card scanner or reader, that can request payment authorization to complete a sale. The merchant computing device 101, which can be any device capable of capturing payment request data on behalf of a merchant, can receive an input (e.g., swipe or dip a card, wireless transmission, keypad entry) of a user's payment card information, such as card verification value (CVV or CVVI), card verification code (CVC or CVC1), card identifier (CID), and payment card number, into the merchant computing device 101. Non-limiting examples of a merchant computing device 101 may include a point of sales (POS) terminal, a payment card payment processing terminal (e.g., a payment card scanner), a server for an online site, and a cash register. Non-limiting examples of payment instruments may include magnetic stripe cards, EMV cards, debit cards, credit cards, stored value cards, gift cards, and virtual cards or tokens that may be stored on a client device 115 (e.g., user computing device, smartphone, or computer). The merchant computing device 101 may comprise or may be coupled to various types of instrument readers configured to capture transaction data from certain types of payment instruments. For instance, if the payment instrument is a virtual card stored on a client device 115, and the client device 115 is configured to transmit payment request data for the virtual card using near field communications (NFC), then the merchant computing device 101 may comprise or may be coupled to an NFC scanner configured to capture the transaction data related to the virtual card via the NFC signal received from the client device 115. The client device can include one or more client applications stored in memory and executed on one or more processors. The client application can present information to the user and receive inputs from the user via, for example, a keyboard, mouse, or touchscreen. The client applications can be stored on a centralized server, such as the Google Play® store or iTunes®, and the user can download the applications from the centralized server to perform functions, such as those describe in this disclosure.

In operation, the merchant computing device 101 may capture payment card information and then generate and transmit a digital message, such as a payment authorization request, comprising the payment card information along with transaction data (e.g., transaction amount, merchant identifier) to a merchant-acquirer server 102. The merchant computing device 101 may be configured to generate digital messages containing the payment authorization request, which includes the payment card information and transaction data, may be generated according to particular protocols or specifications, e.g., one or more ISO standards in which the payment authorization request can contain certain fields for the payment card information and the transaction data. Non-limiting examples of data fields that may be included the digital message may include a merchant identifier (merchant ID), a merchant name, a merchant category code (MCC), an amount for the transaction, a timestamp (e.g., data, time), and a card number. In some implementations, the merchant computing device 101 may transmit the digital message containing the card and/or other payment information to a merchant-acquirer server 102, although in some embodiments, the digital message may be transmitted to other devices, such as an issue processor server 103 of an issue processor system.

Merchant-Acquirer

The merchant-acquirer server 102 may be any computing device configured to process an authorization request from a merchant and forward at least some of the information to an issue processor server 103 over payment network rails 109 or an issue processor system network (e.g., Visa® or MasterCard® networks). A merchant point of sale system can comprise a merchant computing device 101 that is associated with a merchant-acquirer server 102 to process payment card payments. Although one merchant computing device 101 and one merchant-acquirer server 102 is shown, the system may comprise more than one of each the merchant computing device 101 and the merchant-acquirer server 102.

Payment Network Rails

Payment networks (e.g., Visa®, MasterCard®, and American Express®) may be entities that own and operate payment network rails 109, which may be a computing communications network configured to receive and transmit digital messages between merchants and merchant-acquirers to issue processors and issuing banks. In operation, merchant computing devices 101 and merchant-acquirer servers 102 may generate, manipulate, and transmit digital messages containing payment authorization requests. The digital messages may be generated and manipulated according to the policies, standards, and protocols implemented by each particular payment network.

Issue Processor

Issue processor systems can establish payment card number records for customers, issue bills and statements, and process payments. The issue processor server 103 can perform these functions and store transactions and payment card numbers in a storage device, such as database 106. Issue processors will typically forward payment authorization requests to a system of record server 105. However, the example system comprises a server 104 positioned between issue processor server 103 and system of record server 105. Furthermore, the server 104 can perform some or all of the functions typically associated with issue processors, and therefore, in these embodiments, the merchant-acquirer server 102 can communicate over the payment network rails with the server 104. Although the issue processor server 103 and the server 104 are shown as separate computing platforms, the issue processor server 103 and the server 104 can be implemented as a single platform. The positioning of server 104 in between issue processor server 103 and system of record server 105 allows the server 104 to provide added functionality to the system, such as intervene in and record transactions in the payment stream (e.g., intercept payment authorizations). As a result, server 104 can also have access to all transactions associated with an account to provide further services to the client device 115 associated with the account.

Note that FIG. 1 illustrates a four-party scheme (or open scheme) in which the issue processor server 103 is separate from the merchant-acquirer server 102. Embodiments of this disclosure can similarly function with three-party schemes (or closed schemes), such as American Express, Discover Card, and Diners Club, in which the issue processor server 103 and the merchant-acquirer server 102 are the same entity.

The server 104 comprises a memory and a processor, whereby the memory comprises a set of computer-readable instructions that are executed by the processor. Although the server 104 is shown as a single server, it is intended that the functionality of server 104 can be performed by more than one server.

The server 104 of a consumer computing system can be positioned between the issue processor server 103 and the system of record server 105. Server 104 is part of a consumer computing system (“CCS”) 113, which can also include an application programming interface (API) 114 and one or more databases 107a-107n. Server 104 can use API 114 to communicate with client device 115 over user-facing networks 111, such as the internet. Databases 107a-107n can include a profile database, with information such as a user profile, account numbers, and transaction ledgers. With this system architecture, server 104 can intercept transmissions of transaction messages that occur between issue processor server 103 and system of record server 105. The server 104 does not need to perform an action on every transaction message, as the server 104 can just relay the transaction message. After receiving a transaction from issue processor server 103 and recording information from that transaction, server 104 can forward the transaction to system of record server 105.

System of Record

System of record server 105 can be hosted by a bank 116 or a third party that provides a service to a bank 116. Some banks maintain their own system of record servers. The system of record server 105 maintains the accurate information of the balance of an account maintained by bank 116. Other transactions may be pending or in various stages of the payment stream, but the official recordation of those transactions is by the system of record server 105 and database 110. Certain parties, such as the account owner, the merchant, the issue processor, or the CCS 113, may assume certain risks that an account holder does not have sufficient funds to fund a transaction, until the system of record records and authorizes the transaction. However, these parties may assume that risk to process transactions more quickly and efficiently.

Upon receiving a payment authorization request, server 104 can forward associated information to system of record server 105, which maintains an account corresponding to the payment card used in the payment transaction. Bank 116 can maintain the account using the system of record server 105, along with a ledger and other user profile information. System of record server 105 can also include database 110 that can store a copy of the ledger associated with the account record.

Server 104 can also be in communication over user-facing networks 111 (e.g., the internet) with client device 115. Client device 115 is illustrated in FIG. 1 as a smartphone, but can be any computing device, such as any mobile phone, tablet, smart watch, personal data assistant, gaming console, or personal computer. Consumer computing system 113 can also include several databases in communication with server 104, such as database 107a for storing user profile information, and database 107b for storing sub-account balances and ledgers.

Server 104 can communicate transactions to the system of record server 105, which can record in database 110 the payment authorization and further report it to the Federal Reserve and bank 116 that maintains the account record associated with the payment card used in the payment authorization. Bank 116 may also generate an authorization response to forward to the system of record server 105, back though other devices in the payment stream and eventually to the merchant computing device 101 to confirm that the merchant may complete the payment transaction.

Server 104 has a notification engine 108. Upon a determination by the server 104 to alert the client device 115 or otherwise transmit a notification message (or “message”) to the client device 115, the notification engine 108 generates the message (e.g., an alert) for transmission over the user-facing networks 111 to the client device 115. The notification message can be, for example, a notification generated via a mobile OS notification, email message, or text message. The notification engine 108 can query information from databases 107a-107n to obtain data regarding a recent transaction and client device contact information (e.g., mobile phone number for text messaging or an e-mail address for e-mailing). When generating the message, the notification engine 108 can determine how to populate fields of the message using the obtained information. For example, the notification engine 108 can direct the message to the address identified in a contact record for the client device; the address can be, for example, an email address, IP address, or phone number. In another example, the notification engine 108 can calculate how much of a tip to offer based upon a transaction amount. In one embodiment, the notification engine 108 can populate a plurality of tip amount fields in a message based upon the transaction amount. The notification engine 108 is also configured to receive instructions from the server 104. For example, the server 104 may instruct the notification engine 108 when to send a message to the client device 115.

The notification engine 108 of the server 104 can also be configured to receive a response message transmitted from the client device 115 over the user-facing networks 111. When the client device 115 receives a message from the server 104, the client device 115 can generate a message for transmission back to the server 104. This message can be generated via a text messaging application, an e-mail application, or other messaging application on the client device 115. The message generated on the client device 115 can include a selection of an option presented by the notification engine 108 or other data. For example, the message generated by the client device 115 can contain a value representing an amount that the user of the client device 115 intends to tip in the subject transaction. The server 104 can process the selection or other data (e.g., tip amount) and determine whether the received value is the same as the value transmitted via the authorization process for that same transaction.

A tippable transaction can be processed using a single authorization request containing a tip in a final amount or using two authorization requests from the merchant. In a two-message authorization request process, upon receiving an input that includes a tippable transaction, the merchant computing device 101 generates an initial request message that includes a final amount of the transaction for authorization. This message can be hashed and encrypted when transmitted to the merchant-acquirer server. The merchant-acquirer server 102 receives the message and decrypts it for processing. The merchant-acquirer server 102 creates a clearing request for transmission to the issue processor system via the payment rails for authorization. At a later time, once the merchant computing device 101 receives an input of a merchant tip amount, the merchant computing device 101 stores the merchant tip amount in a record of database 107, then generates a capture message with the tip and final amount for authorization. This subsequent message contains an indicator that it is an updated transaction. Upon receiving the authorization request, the server 104 of the consumer computing system can accept or decline the transaction.

The server 104 of the consumer computing system determines whether to authorize the initial or subsequent capture message transaction requests. The server 101 can make this determination based upon a determination of risk, an assessment of the customer balance, and the like.

During the authorization process, when the server 104 receives a transaction request that is tip eligible, the server 104 causes a notification to be generated and transmitted (e.g., via SMS message, push notification, or e-mail) for display on the client device 115. The notification can include a tip suggestion as well as a suggestion of the associated total (authorization amount plus tip). The notification can also include an outstanding balance as of the authorization. In one embodiment, the suggested tip amount is not binding, and the customer can use any tip amount in the transaction. The server 104 will proceed to authorize the tip amount in the capture message, even if it differs from the amount in the notification message. In another embodiment, once the customer selects a tip amount via an interface on the client device 115, and that selection is transmitted back to the server 104, the customer is bound by the selected tip amount.

In an example where the customer is bound by the selected tip amount, the server 104 may generate a decline request when the merchant tip amount in the payment request authorization message is not the same as the selected tip amount represented by the value in the database 107 record. Upon a determination that there is no match, the notification engine 108 may automatically generate a notification message for the client device 115 alerting the customer to the unexpected capture amount. The server 104 may also transmit a message to the issue processor system server 103 or the system of record server 105 requesting that authorization for the transaction be declined. The server 104 can also request initiation of a charge back. The charge back can be the total amount of the transaction or a difference between the selected tip amount and the merchant tip amount.

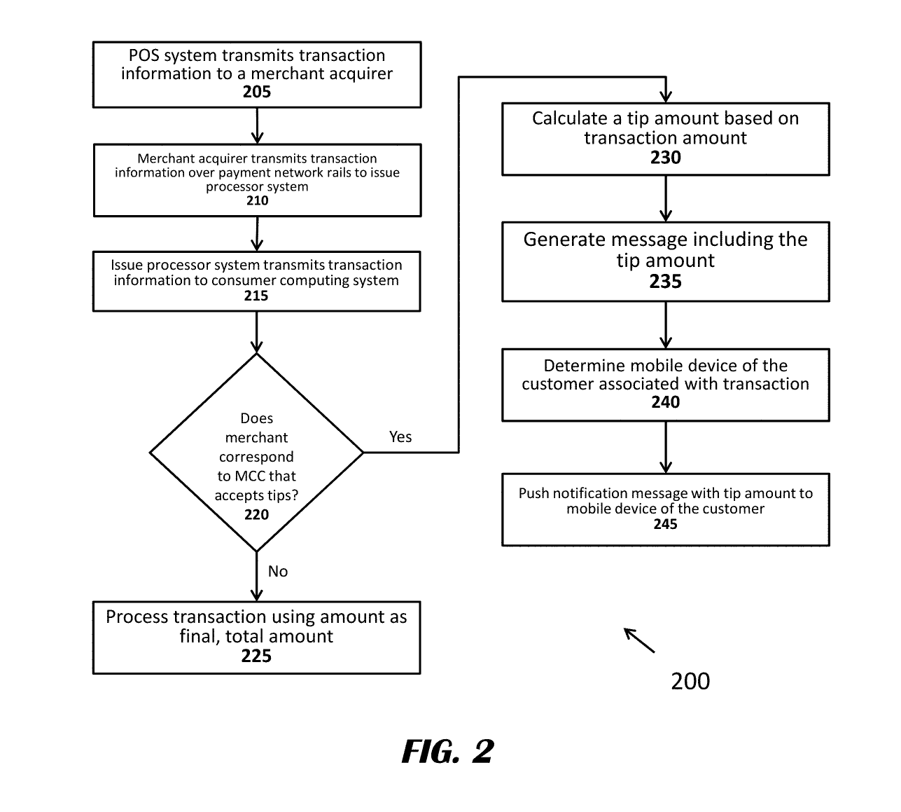

FIG. 2 illustrates a data flow diagram of a tip amount notification message system, according to an example embodiment. This example flow 200 begins at a merchant point of sale transmitting transaction information to the merchant-acquirer, in step 205. The merchant, such as a restaurant, can swipe a magnetic stripe of a payment card, insert an EMV chip card into a point of sale chip card reader, contactless payment via wireless card reader (e.g., NFC), or otherwise input the payment card information into the point of sale system. The point of sale system transmits the payment card number and transaction amount, along with information such as expiration date and name of the customer.

In step 210, the merchant-acquirer transmits the transaction information over payment network rails to the issue processor system. The payment network rails may be proprietary for each issue processor system, or issue processor systems may share a network. The issue processor system can begin the authorization process for a transaction request.

In a conventional transaction, the authorization message may be transmitted from the issue processor system directly to a system of record, but the notification system described herein has a consumer computing system positioned to receive from the issuer processor system. In step 215, the issue processor system transmits the authorization message to the consumer computing system.

The consumer computing system can determine whether the transaction with merchant should include a tip. The consumer computing system can use information from one or more of the merchant name, merchant identifier, or MCC code. For example, the consumer computing system can the MCC code to determine whether to generate instructions for processing the transaction as a tip transaction.

The merchant is associated with a MCC or other code, such as North American Industry Classification System (NAICS), that identifies a primary business or industry category of the merchant. The MCC can be assigned by the issue processor system or the consumer computing system and can be stored in an associated database. Upon receiving the authorization message, the merchant's MCC is identified to determine the primary business category. The primary business or industry category can be used to determine whether the merchant customarily accepts tips with each transaction. A merchant that customarily accepts tips with each transaction will likely present a tip amount field on a receipt presented to a customer after initially authorizing the transaction for a subtotal amount. In one example, MCC 5812 corresponds to “eating places and restaurants,” which customarily accepts tips. In another example, MCC 5813 corresponds to “drinking places (alcoholic beverages), bars, taverns, cocktail lounges, nightclubs, and discotheques,” which customarily accepts tips. In yet another example, MCC 5814 corresponds to “fast food restaurants,” which does not customarily receive tips. In step 220, the consumer computing system determines whether a suggested tip notification message should be transmitted based on only those transactions at certain merchants. In this example, transactions initiated by a merchant corresponding to MCCs 5812 or 5813 would cause such a notification message, but a transaction initiated by a merchant associated with MCC 5814 would not cause the tip amount notification message.

In step 225, if the MCC does not correspond to a merchant that customarily accepts tips, the authorization message will proceed using the transaction amount as the final, total amount.

In step 230, if the MCC corresponds to a merchant that customarily accepts tips, then the consumer computing system automatically calculates a tip amount based upon the amount in the authorization request. In one embodiment, the consumer computing system may set a default tip percentage, which may be selected by the customer. For example, the consumer computing system can have a default tip percentage of 20%, so any transaction amount will initiate a calculation of a tip based upon 20% of the transaction amount. In another embodiment, the consumer computing system can present the customer with more than one option for a tip. For example, the consumer computing system can present a tip amount based upon 10% of the transaction, 15% of the transaction, and 25% of the transaction. Although these example percentages are used, it is intended that any number of tip amounts can be presented, and any tip percentages may be used.

In step 235, the notification engine of the consumer computing system generates a notification message to be transmitted to the customer's client device, which is described in this example embodiment as a mobile device, such as a cellular phone or a smartphone. The notification message can be SMS message, MMS message, or other application-based message. For example, if the mobile device of the customer has an application installed on the mobile device associated with the consumer computing system, the consumer computing system can transmit instructions to mobile device to restore the application to execute a notification for presentation on the mobile device.

In step 240, the consumer computing system determines an address of the mobile device of the customer. The consumer computing system can use the payment card number, which may be associated with a mobile device address in the user account database. The address may be a phone number or any other identifiable information used to send a notification message to that mobile device.

In step 245, the notification engine of the consumer computing system pushes the notification message having the tip amount to the mobile device of the customer. As described above, the notification message is generated and transmitted upon the receipt of an authorization message from a merchant having a MCC that corresponds to an industry that typically accepts tips.

In one embodiment, the notification message is pushed to the mobile device within a certain time period to ensure it is useful in the transaction. Because of the automatic generation and transmission of the notification message, the notification message is configured to be sent as soon as possible after the receipt of the authorization message, which may be in real time or take just a few seconds. In one embodiment, a time period for pushing the notification message has an end time, such that if generation and transmission of the notification message is to occur after the end time, then the notification message will not be sent. A customer may be completing a transaction, but the customer does not want to stay beyond a certain length of time at a restaurant, in the back of a taxi cab, or at a bar waiting for the tip amount to be transmitted. The consumer computing system may set a default end time, which may be selected by the customer. If the consumer computing system receives an authorization message comprising a tip amount before the notification message is pushed to the mobile device, then the notification message will not be sent. Accordingly, the consumer computing system is configured to push the notification message to the mobile device within a time period to maintain the benefit of the service.

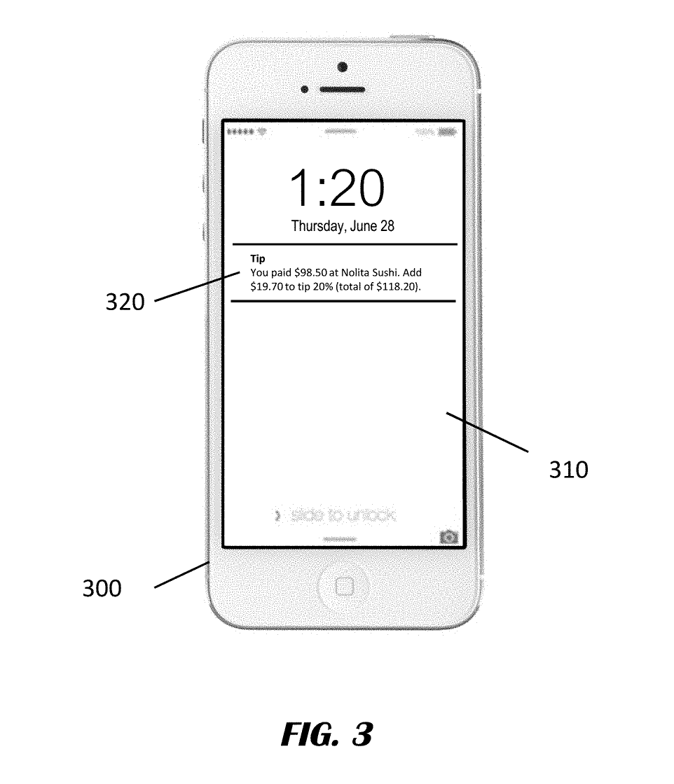

FIG. 3 illustrates a graphical user interface 310 of a mobile device 300 that received a push notification message 320, according to an example embodiment. In this example embodiment, the push notification message 320 is shown on a locked home screen of the mobile device 300. In this example, the push notification message says, “You paid $98.50 at Nolita Sushi. Add $19.70 to tip 20% (total of $118.20).” This example notification message includes the transaction amount (e.g., $98.50), a suggested tip amount ($19.70 based upon 20% of the transaction amount), a total amount ($118.20), and the name of the merchant. Including the name of the merchant can assist the customer with ensuring a secure transaction, because the customer may not be present at that merchant when a fraudulent transaction is being processed, so the customer can terminate the transaction immediately.

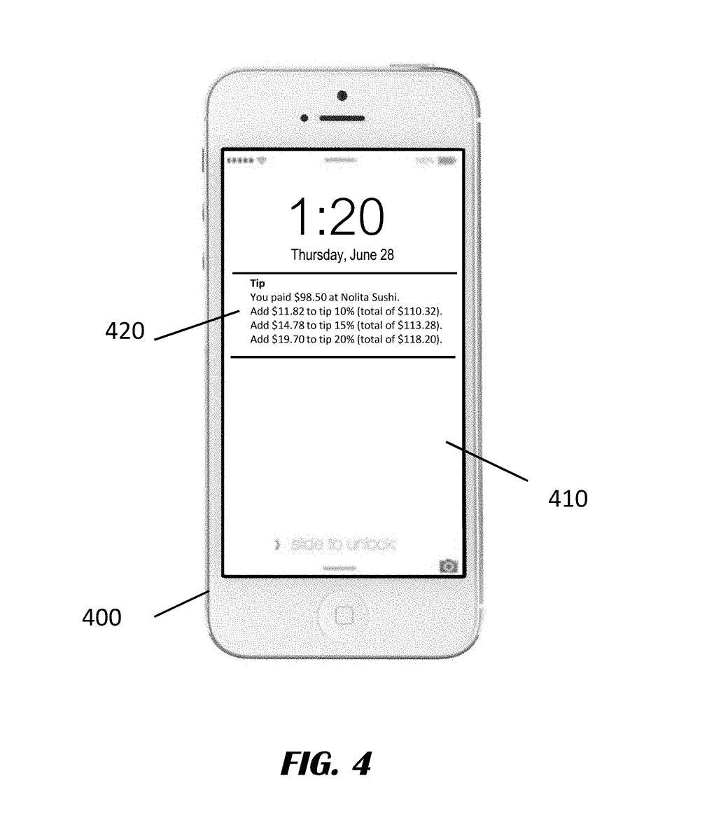

FIG. 4 illustrates a graphical user interface 410 of a mobile device 400 that received a push notification message 420, according to an alternative example embodiment. In this example embodiment, the push notification message 420 is shown on a locked home screen of the mobile device 400. In this example, the push notification message says, “You paid $98.50 at Nolita Sushi. Add $11.82 to tip 10% (total of $110.32). Add $14.78 to tip 15% (total of $113.28). Add $19.70 to tip 20% (total of $118.20).” The notification message includes the transaction amount (e.g., $98.50), a suggested tip amount using three different tip percentages (based upon 10%, 15%, and 20% of the transaction amount), a total amount for each tip percentage, and the name of the merchant.

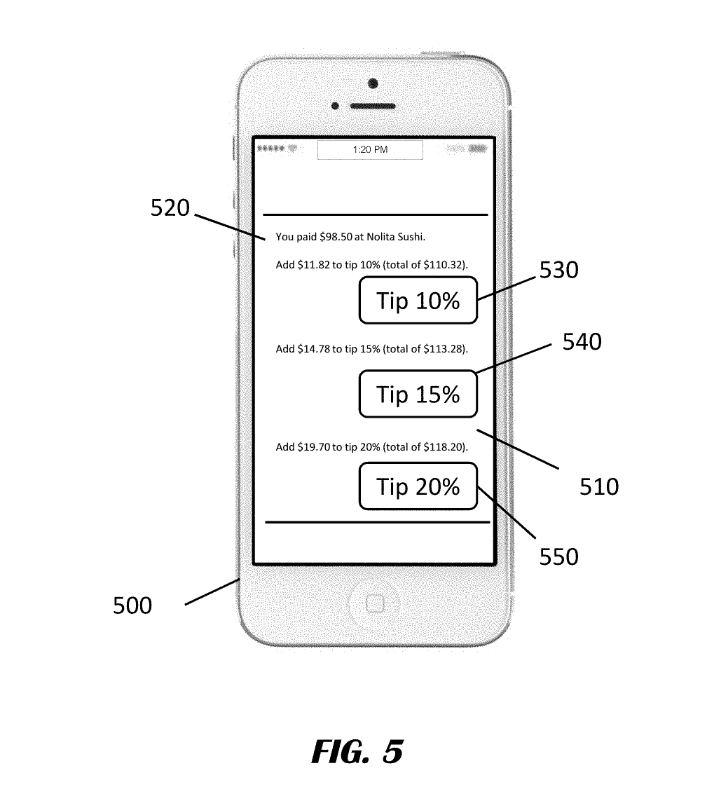

FIG. 5 illustrates a graphical user interface 510 of a mobile device 500 that presents a selection of a tip based on recommended tip amounts, according to an example embodiment. A message 520 on the graphical user interface says, “You paid $98.50 at Nolita Sushi.” A plurality of buttons 530, 540, 550 are presented on the graphical user interface 510 for selection by the customer. Button 530 corresponds to a selection of a 10% tip for the transaction and is presented after a message of “Add $11.82 to tip 10% (total of $110.32).” Button 540 corresponds to a selection of a 15% tip for the transaction and is presented after a message of “Add $14.78 to tip 15% (total of $113.28).” Button 550 corresponds to a selection of a 20% tip for the transaction and is presented after a message of “Add $19.70 to tip 20% (total of $118.20).” The recommended tip amount can also include an average tip amount. For instance, the server can monitor tip amounts from other users and average them together to get an typical tip amount, e.g., 22%. The server can then provide this average tip amount to the user. Note that the average tip amount can vary between merchants. Still further, the suggested tip amount may be determined by the consumer computing system based on average tip amounts given the by the user in the past for that particular merchant or, alternatively, for merchants of that particular MCC. Also, the suggested tip amount may be based upon a classification of the merchant (e.g., upscale merchant may require higher suggested tip) or the profile of the user (e.g., young, middle-class user may see a different suggested tip amount than an older upper middle-class user).

In an example, a diner finishes his meal at a restaurant and gives his payment card to a waiter. The waiter swipes the card at a point of sale system to capture the payment card information and an amount of a bill. The diner's mobile device receives a push notification that recites the subtotal of $122.45 and three buttons associated with: “15%: $18.37; total $140.82;” “18%: $22.04, total $144.49;” and “20%: 24.49, total $146.94.” The diner taps the “18%” button on the mobile device, which is transmitted back to the consumer computing system. The diner receives a receipt, on which he enters the tip amount corresponding to 18% ($22.04), the total ($144.49), and signs the receipt. If the waiter alters the tip amount to $32.04 and the total to $154.49, then the transaction will be declined by the consumer computing system. The consumer computing system will generate and transmit a notification message warning the diner of the unexpected capture amount.

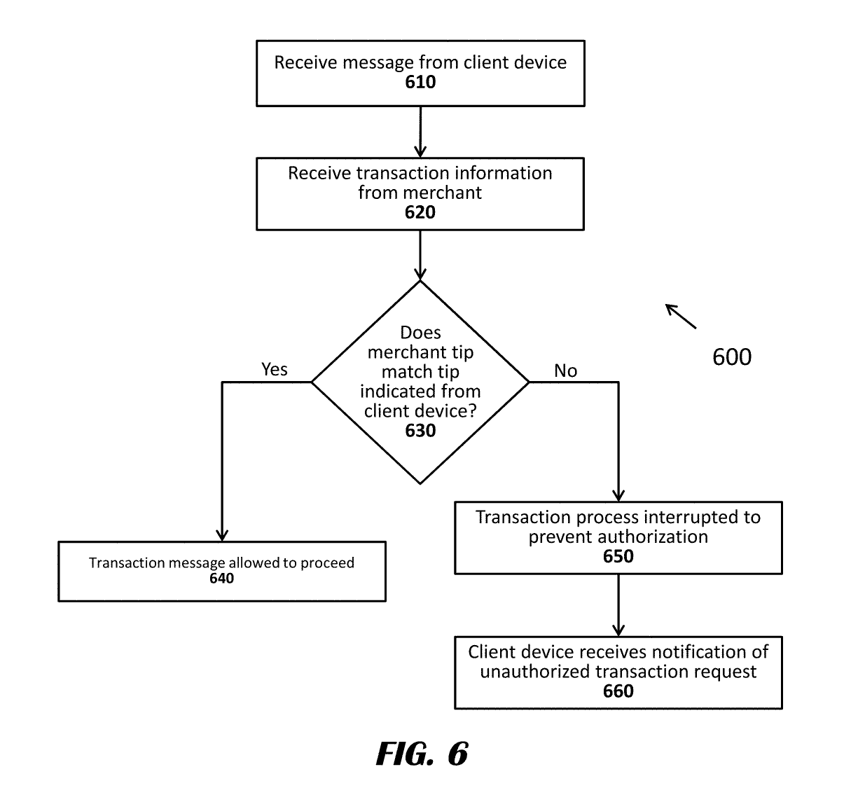

FIG. 6 illustrates a data flow diagram 600 of a warning notification message system, according to an example embodiment, whereby a notification message has been transmitted to a client device with one or more suggested tip amounts, as described in the example embodiment of FIG. 2. In step 610, upon receiving a message from the client device comprising a selection of a tip amount, the server populates a database record (or “record”) for a transaction associated with the account number corresponding to the client device that transmitted the message. The record is populated with the tip amount in a field corresponding to the transaction information.

In step 620, the server receives transaction information via the payment rails. The transaction information contains a first value representing the sub-total amount, a second value representing a tip amount, a third value representing a total amount, and an account number. The server populates a record for the transaction associated with the account number. Although step 620 is shown as occurring after step 610, step 620 can be performed before step 610, or steps 610, 620 can be performed simultaneously.

In step 630, the server determines whether the tip amount from the client device matches the second value received over the payment rails to determine whether the user entered a tip amount that is the same as the tip amount transmitted from the merchant.

In one embodiment, if the server does not receive a message from the client device, the transaction can still be authorized. The server may not receive a message if the client device is off or has no or limited network connectivity. Accordingly, the server may have a time window in which a response is expected from the client device, and if the server times out, the server will not decline the transaction due to a tip amount entry.

In step 640, when these values are the same, the server allows the transaction to proceed. The server may relay a transaction request message from the payment rails or an issue processor system to the system of record. The server can update the database accordingly.

In step 650, when these values are not the same, the server can prevent the transaction from proceeding. The server may intercept the transaction request message from the payment rails or the issue processor system and prevent the transaction from reaching the system of record. The server can update the database accordingly.

In step 660, the server can transmit a message to the client device indicating that the transaction was processed by the merchant using a different amount than the amount. This message transmitted to the client device alerts the account holder in a more efficient manner than conventional systems, which may require the account holder to confirm the desired transaction amount with the merchant-submitted transaction weeks later when the account statement is transmitted or otherwise delivered to the account holder. Additionally, example embodiments serve to improve the authorization and transaction payment flow between payment processing systems when conducting transactions involving post-authorization tipping, while also signaling time-sensitive fraudulent activity to unsuspecting consumers.

Although certain illustrative, non-limiting example embodiments have been presented, various changes, substitutions, permutations, and alterations can be made without departing from the scope of the appended claims. Further, the steps of the methods described herein may be carried out in any suitable order, or simultaneously where appropriate. Thus, the scope of the invention should not necessarily be limited by this description.

Unless specifically stated otherwise as apparent from the following discussion, it is appreciated that throughout the description, discussions utilizing terms such as “processing,” “computing,” “transmitting,” “receiving,” “determining,” “displaying,” “identifying,” “presenting,” “establishing,” or the like, can refer to the action and processes of a data processing system, or similar electronic device that manipulates and transforms data represented as physical (electronic) quantities within the system's registers and memories into other data similarly represented as physical quantities within the system's memories or registers or other such information storage, transmission or display devices. The system or portions thereof may be installed on an electronic device.

The example embodiments can relate to an apparatus for performing one or more of the functions described herein. This apparatus may be specially constructed for the required purposes, or it may comprise a special purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions for operations on a processor, and each coupled to a bus.

The example embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. These devices can include a network interface, such as a wireless network adapter (e.g., Wi-Fi, LTE, CDMA, or GSM), or wired network adapter (e.g., Ethernet). In general, any device capable of implementing the processes described herein can be used to implement the systems and techniques according to this invention.

The example embodiments can relate to an apparatus for performing one or more of the functions described herein. This apparatus may be specially constructed for the required purposes or be selectively activated or reconfigured by computer executable instructions stored in non-transitory computer memory medium or non-transitory computer-readable storage medium.

It is to be appreciated that the various components of the technology can be located at distant portions of a distributed network or the Internet, or within a dedicated secured, unsecured, addressed/encoded or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying or communicating data to and from the connected elements. The term “module” as used herein can refer to any known or later developed hardware, software, firmware, or combination thereof that is capable of performing the functionality associated with that element.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of all examples, or example language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The terms “connected” or “coupled” and related terms used throughout the description are used in an operational sense and are not necessarily limited to a direct physical connection or coupling. Thus, for example, two devices may be coupled directly, or via one or more intermediary media or devices. As another example, devices may be coupled in such a way that information can be passed there-between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” and the like generally mean the particular feature, structure, or characteristic following the phrase is included in at least one implementation of the disclosed technology, and may be included in more than one implementation. In addition, such phrases do not necessarily refer to the same embodiments or different embodiments.

The term “module” or “engine” refers broadly to general or specific-purpose hardware, software, or firmware (or any combination thereof) components. Modules and engines are typically functional components that can generate useful data or other output using specified input(s). A module or engine may or may not be self-contained. Depending upon implementation-specific or other considerations, the modules or engines may be centralized or functionally distributed. An application program (also called an “application”) may include one or more modules and/or engines, or a module and/or engine can include one or more application programs.

The term “cause” and variations thereof, as used throughout this description, refers to either direct causation or indirect causation. For example, a computer system can “cause” an action by sending a message to a second computer system that commands, requests or prompts the second computer system to perform the action. Any number of intermediary devices may examine and/or relay the message during this process. In this regard, a device can “cause” an action even though it may not be known to the device whether the action will ultimately be executed or completed.

Presently preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method for displaying a notification message on a mobile device, the method comprising:
upon receiving, by a server, a payment request authorization message transmitted over a issue processor system network and initiated from a merchant point of sale system, the payment request authorization message comprising a payment card number and a transaction amount of a transaction:
determining, by the server, whether a merchant category code of a merchant associated with the merchant point of sale system that initiated the payment request authorization message matches one of a set of merchant category codes associated with a tip amount field;
when the payment request authorization message is associated with a merchant category code associated with the tip amount field:
automatically generating, by the server, a notification message comprising a recommended tip amount based upon a percentage of the transaction amount in the payment request authorization message;
identifying, by the server, in a profile database, an address of a mobile device associated with the payment card number;
pushing, by the server, the notification message containing the recommended tip amount to the mobile device upon receiving the payment request authorization message and before authorization of the transaction;
upon receipt of a reply message from the mobile device, updating, by the server, a database record associated with the transaction to contain a value of a selected tip amount;
authorizing, by the server, the payment request authorization message when a merchant tip amount in the payment request authorization message is the same as the selected tip amount represented by the value in the database record; and
generating, by the server, a decline request when the merchant tip amount in the payment request authorization message is not the same as the selected tip amount represented by the value in the database record.

2. The method according to claim 1, further comprising populating, by the server, the notification message with a first value representing the recommended tip amount and a second value representing a second recommended tip amount.

3. The method according to claim 2, wherein the first value and the second value of the notification message are configured to be populated in a message for display on a user interface of the mobile device.

4. The method according to claim 3, whereby the user interface populates the message for display having the first value associated with a first selectable link and the second value associated with a second selectable link.

5. The method according to claim 1, wherein the notification message comprises a text message or an e-mail message.

6. A computer-implemented method comprising:
receiving, by a consumer computing system server, an authorization message transmitted over a issue processor system network, the authorization message comprising a payment card number and a transaction amount of a transaction;
generating, by the consumer computing system server, a notification message comprising a recommended tip amount based upon a percentage of the transaction amount in the authorization message;
identifying, by the consumer computing system server, an address of a mobile device associated with the payment card number; and
pushing, by the consumer computing system server, the notification message containing the recommended tip amount to the mobile device upon receiving the authorization message.

7. The method according to claim 6, further comprising populating, by the consumer computing system server, the notification message with a first value representing the recommended tip amount and a second value representing a second recommended tip amount.

8. The method according to claim 7, wherein the first value and the second value of the notification message are configured to be populated in a message for display on a user interface of the mobile device.

9. The method according to claim 8, whereby the user interface populates the message for display having the first value associated with a first selectable link and the second value associated with a second selectable link.

10. The method according to claim 9, wherein upon receipt of a reply message from the mobile device, updating, by the consumer computing system server, a database record associated with the transaction to contain a value of a selected tip amount.

11. The method according to claim 10, further comprising authorizing, by the consumer computing system server, the authorization message when a merchant tip amount in the payment request authorization message is the same as the selected tip amount represented by the value in the database record.

12. The method according to claim 11, further comprising generating, by the server, a decline request when the merchant tip amount in the payment request authorization message is not the same as the selected tip amount represented by the value in the database record.

13. The method according to claim 8, wherein the notification message comprises a text message or an e-mail message.

14. A notification system comprising:
a network interface through which to communicate with one or more mobile devices;
a processor coupled to the network interface; and
a memory coupled to the processor, the memory storing instructions comprising:
instructions for receiving a payment request authorization message transmitted over a issue processor system network initiated from a merchant point of sale system, the payment request authorization message comprising a payment card number and a transaction amount of a transaction;
instructions for determining, upon receiving the payment request authorization message, whether an industry category of a merchant associated with a merchant point of sale system that initiated the payment request authorization message matches one of a set of industry categories associated with a tip amount field;
instructions for automatically generating a notification message comprising a recommended tip amount based upon a percentage of the transaction amount in the payment request authorization message when the payment request authorization message is associated with an industry category associated with the tip amount field;
instructions for identifying, in a profile database, an address of a mobile device associated with the payment card number; and
instructions for pushing the notification message containing the recommended tip amount to the mobile device upon receiving the payment request authorization message and before authorization of the transaction.

15. The notification system according to claim 14, wherein the memory further comprises instructions for populating the notification message with a first value representing the recommended tip amount and a second value representing a second recommended tip amount.

16. The notification system according to claim 15, wherein the first value and the second value of the notification message are configured to be populated in a message for display on a user interface of the mobile device.

17. The notification system according to claim 16, whereby the user interface populates the message for display having the first value associated with a first selectable link and the second value associated with a second selectable link.

18. The notification system according to claim 17, wherein the memory further comprises instructions for updating a database record associated with the transaction to contain a value of a selected tip amount upon receipt of a reply message from the mobile device.

19. The notification system according to claim 18, wherein the memory further comprises instructions for authorizing the payment request authorization message when a merchant tip amount in the payment request authorization message is the same as the selected tip amount represented by the value in the database record.

20. The notification system according to claim 19, wherein the memory further comprises instructions for generating a decline request when the merchant tip amount in the payment request authorization message is not the same as the selected tip amount represented by the value in the database record.

21. The notification system according to claim 14, wherein the notification message comprises a text message or an e-mail message.

22. A computer-readable storage medium of a server storing instructions that, when executed by a computing system, cause the computing system to perform a method comprising:
receiving, by the server, a payment request authorization message transmitted over a issue processor system network initiated from a merchant point of sale system, the payment request authorization message comprising a payment card number and a transaction amount of a transaction;
determining, by the server, upon receiving the payment request authorization message, whether an industry category of a merchant associated with the merchant point of sale system that initiated the payment request authorization message matches one of a set of industry categories associated with a tip amount field;
automatically generating, by the server, a notification message comprising a recommended tip amount based upon a percentage of the transaction amount in the payment request authorization message when the payment request authorization message is associated with an industry category associated with the tip amount field;
identifying, by the server, in a profile database, an address of a mobile device associated with the payment card number; and
pushing, by the server, the notification message containing the recommended tip amount to the mobile device upon receiving the payment request authorization message and before authorization of the transaction.

23. The computer-readable storage medium according to claim 22, further comprising populating, by the server, the notification message with a first value representing the recommended tip amount and a second value representing a second recommended tip amount.

24. The computer-readable storage medium according to claim 23, wherein the first value and the second value of the notification message are configured to be populated in a message for display on a user interface of the mobile device.

25. The computer-readable storage medium according to claim 24, whereby the user interface populates the message for display having the first value associated with a first selectable link and the second value associated with a second selectable link.

26. The computer-readable storage medium according to claim 25, wherein upon receipt of a reply message from the mobile device, updating, by the server, a database record associated with the transaction to contain a value of a selected tip amount.

27. The computer-readable storage medium according to claim 26, further comprising authorizing, by the server, the payment request authorization message when a merchant tip amount in the payment request authorization message is the same as the selected tip amount represented by the value in the database record.

28. The computer-readable storage medium according to claim 27, further comprising generating, by the server, a decline request when the merchant tip amount in the payment request authorization message is not the same as the selected tip amount represented by the value in the database record.

29. The computer-readable storage medium according to claim 22, wherein the notification message comprises a text message or an e-mail message.
